(19) United States
(12) Patent Application Publication
(10) Pub. No.: US 2011/0304602 A1
(43) Pub. Date: Dec. 15, 2011

(54) DISPLAY APPARATUS AND DISPLAY PANEL THEREOF

(75) Inventors: Ying-Hui Chen, Taoyuan County (TW); Wen-Chih Tai, Taoyuan County (TW); Chia-Lin Liu, Taichung County (TW)

(73) Assignee: CHUNGHWA PICTURE TUBES, LTD., Taoyuan (TW)

(21) Appl. No.: 12/848,236

(22) Filed: Aug. 2, 2010

(30) Foreign Application Priority Data
Jun. 15, 2010 (TW) 99211463

(51) Int. Cl. G09G 5/00; G09G 3/36

(52) U.S. Cl. 345/211; 345/90

(57) ABSTRACT

A display apparatus and a display panel. The display panel includes a first scanning line, a plurality of second scanning lines, a plurality of first pixels and a plurality of second pixels. The first scanning line receives a first scanning signal. The second scanning lines receive a second scanning signal, where the second scanning signal is different from the first scanning signal. The first pixels are coupled to the corresponding second and first scanning lines. The second pixels are coupled to the two corresponding second scanning lines respectively. By adjusting a capacitance of a capacitor, a voltage level of the second scanning signal, or a line impedance of the second scanning line, a pixel voltage difference of the first pixel equals to a pixel voltage difference of the second pixel.

### CROSS-REFERENCE TO RELATED APPLICATION

This application claims the priority benefit of Taiwan application serial no. 99211463, filed on Jun. 15, 2010. The entirety of the above-mentioned patent application is hereby incorporated by reference herein and made a part of specification.

### BACKGROUND OF THE INVENTION

1. Field of the Invention

The invention relates to a display panel and a display apparatus, and more particularly to a display panel capable of turning on multiple rows of pixels simultaneously and a display apparatus having the display panel.

2. Description of Related Art

Recently, portable electronic products and flat panel displays become popularized along with the increasing development of semiconductor technology. Among various types of flat panel displays, thin film transistor liquid crystal displays (TFT-LCDs) are the main stream of the displays based on their advantages of low voltage operation, radiation-free scattering, light weight, compact volume, and so on. Generally, in conventional LCD apparatuses, only one scanning line is disposed between every two rows of pixels in display panels, and pixels in the same column share a data line. Accordingly, a row of pixels is driven through a scanning line and a plurality of pixel voltages is transmitted to the driven pixels through a plurality of data lines respectively.

In order to display images with superior quality, the size, resolution and image update rate of display panels are all enhanced consistently. As resolution and image update rate of display panels are enhanced continuously, a charging time of the pixels in the conventional display panels also decreases continuously. Moreover, the charging time may be insufficient, such that the quality of the image displayed is poor. Thus, display panels capable of driving multiple rows of pixels simultaneously are developed from the researches and improvements of manufacturers. When multiple rows of pixels are driven, each driven pixel receives a pixel voltage through different data lines respectively so as to increase the charging time of each of the pixels.

Since the manner of driving multiple rows of pixels simultaneously is different from the conventional manner of driving one row of pixels at a time, a circuit operation of driving multiple rows of pixels is different from before. In addition, in the pixels simultaneously driven, a pixel voltage difference of a first row of pixels after being input a pixel voltage is smaller than those of the other rows of pixels, such that the pixel voltage displayed by the first row of pixels is higher than those of the other rows of pixels. Therefore, when displaying an image, the display panel shows a plurality of brighter or darker horizontal lines and the display quality of the display panel is affected consequently.

### SUMMARY OF THE INVENTION

The invention is directed to a display panel capable of maintaining a pixel voltage difference of each of a plurality of pixels the same before and after a pixel voltage is input.

The invention is directed to a display apparatus capable of enhancing a display quality of an image displayed by each of a plurality of pixels.

The invention is directed to a display panel including a first scanning line, a plurality of second scanning lines, a plurality of first pixels, and a plurality of second pixels. The first scanning line receives a first scanning signal. The second scanning lines receive a second scanning signal, where the second scanning signal is different from the first scanning signal. Each of the first pixels includes a first switch, a first storage capacitor, a first liquid crystal capacitor, a first capacitor, and a second capacitor. The first switch has a first end receiving a first pixel voltage and a control end coupled to the corresponding second scanning line. The first storage capacitor is coupled between a second end of the first switch and a common voltage. The first liquid crystal capacitor is coupled to the second end of the first switch. The first capacitor is coupled between the first scanning line and the second end of the first switch. The second capacitor is coupled between the corresponding second scanning line and the second end of the first switch. The second pixels are coupled to the two corresponding second scanning lines respectively. Each of the second pixels includes a second switch, a second storage capacitor, a second liquid crystal capacitor, a third capacitor, and a fourth capacitor. The second switch has a first end receiving a second pixel voltage and a control end coupled to one of the two corresponding second scanning lines. The second storage capacitor is coupled between a second end of the second switch and the common voltage. The second liquid crystal capacitor is coupled to the second end of the second switch. The third capacitor is coupled between another one of the two corresponding second scanning lines and the second end of the second switch. The fourth capacitor is coupled between one of the two corresponding second scanning lines and the second end of the second switch. By adjusting a capacitance of the second capacitor, a capacitance of the first storage capacitor, a voltage level of the second scanning signal corresponding to the first pixels, or a line impedance of the second scanning line corresponding to the first pixels, a pixel voltage difference of the first storage capacitor equals to a pixel voltage difference of the second storage capacitor.

The invention is further directed to a display apparatus including a display panel, a source driver, and a gate driver. The display panel includes a first scanning line, a plurality of second scanning lines, a plurality of first pixels and a plurality of second pixels. The first scanning line receives a first scanning signal. The second scanning lines receive a second scanning signal, where the second scanning signal is different from the first scanning signal. Each of the first pixels includes a first switch, a first storage capacitor, a first liquid crystal capacitor, a first capacitor, and a second capacitor. The first switch has a first end receiving a first pixel voltage and a control end coupled to the corresponding second scanning line. The first storage capacitor is coupled between a second end of the first switch and a common voltage. The first liquid crystal capacitor is coupled to the second end of the first switch. The first capacitor is coupled between the first scanning line and the second end of the first switch. The second capacitor is coupled between the corresponding second scanning line and the second end of the first switch. The second pixels are coupled to the two corresponding second scanning lines respectively. Each of the second pixels includes a second switch, a second storage capacitor, a second liquid crystal capacitor, a third capacitor, and a fourth capacitor. The second switch has a first end receiving a second pixel voltage and a control end coupled to one of the two corresponding second scanning lines. The second storage capacitor is coupled between a second end of the second switch and the common voltage. The second liquid crystal capacitor is coupled to the second end of the second switch. The third capacitor is coupled between another one of the two corresponding second scanning lines and the second end of the second switch. The fourth capacitor is coupled between one of the two corresponding second scanning lines and the second end of the second switch. The source driver is coupled to the first pixels and the second pixels to provide the first pixel voltage and the second pixel voltage thereto. The gate driver is coupled to the first scanning line and the second scanning lines to provide the first scanning signal and the second scanning signal thereto. By adjusting a capacitance of the second capacitor, a capacitance of the first storage capacitor, a voltage level of the second scanning signal corresponding to the first pixels, or a line impedance of the second scanning line corresponding to the first pixels, a pixel voltage difference of the first storage capacitor equals to a pixel voltage difference of the second storage capacitor.

In one embodiment of the invention, the capacitance of the second capacitor equals to a sum of a capacitance of the third capacitor and a capacitance of the fourth capacitor, and the capacitance of the first storage capacitor equals to a capacitance of the second storage capacitor subtracting a capacitance of the third capacitor.

In one embodiment of the invention, the capacitance of the first storage capacitor is smaller than that of the second storage capacitor.

In one embodiment of the invention, the voltage level of the second scanning signal corresponding to the first pixels is higher than voltage levels of the remaining second scanning signals.

In one embodiment of the invention, the line impedance of the second scanning line corresponding to the first pixels is higher than the line impedances of the remaining second scanning lines.

In one embodiment of the invention, the first capacitor, the second capacitor, the third capacitor, and the fourth capacitor are a coupling capacitor respectively.

In one embodiment of the invention, the display panel is a liquid crystal display panel.

In one embodiment of the invention, the display apparatus further includes a backlight module configured to provide a surface light source required by the display panel.

In light of the foregoing, in the display apparatus and the display panel of the invention, the capacitance of the second capacitor, the capacitance of the first storage capacitor, the voltage level of the gate high voltage of the second scanning signal corresponding to the first pixels, or the line impedance of the second scanning line corresponding to the first pixels can be adjusted. Accordingly, the pixel voltage difference of the first pixels equals to the pixel voltage difference of the second pixels.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 illustrates a schematic system diagram of a display apparatus according to an embodiment of the invention.

FIG. 2 shows a schematic circuit diagram of a pixel P11 in FIG. 1 according to an embodiment of the invention.

FIG. 3 shows a waveform of a plurality of scanning signals SC1-SC6 in FIG. 1 according to an embodiment of the invention.

FIG. 4 illustrates a waveform of pixel voltages of the pixel P11 and a pixel P21 in FIG. 1 according to an embodiment of the invention.

### DESCRIPTION OF EMBODIMENTS

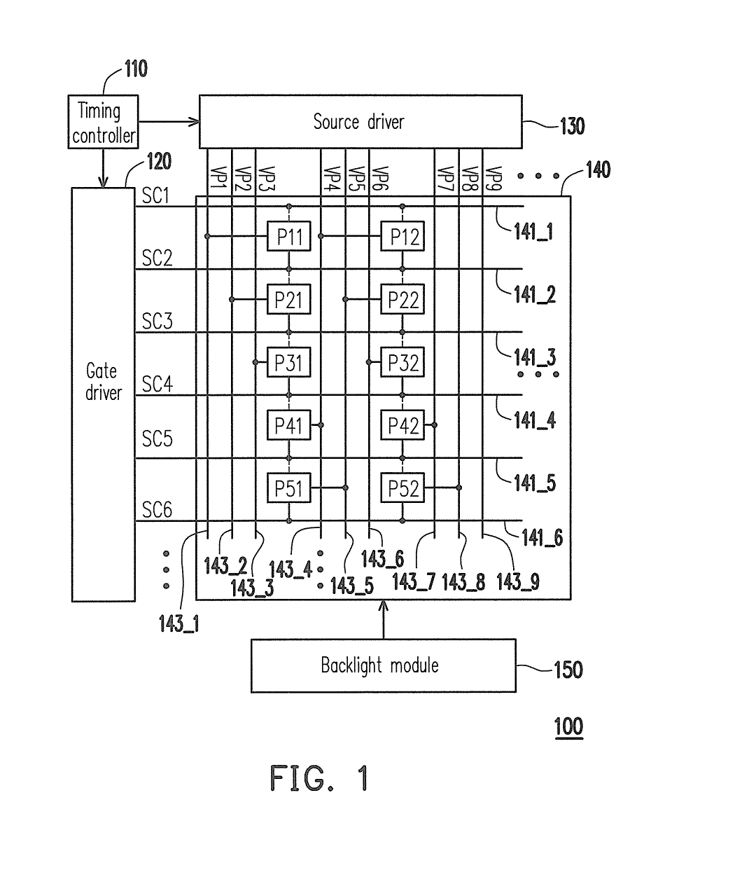

FIG. 1 illustrates a schematic system diagram of a display apparatus according to an embodiment of the invention. Referring to FIG. 1, in the present embodiment, a display apparatus 100 includes a timing controller 110, a gate driver 120, a source driver 130, a display panel 140, and a backlight module 150. The display panel 140 is a liquid crystal display (LCD) panel and includes a plurality of scanning lines (i.e. 141_{—1-141}_6), a plurality of data lines (i.e. 143_{—1-143}_9), and a plurality of pixels (i.e. P11, P12, P21, P22, and so on). Herein, the pixel P11 is coupled to the scanning line 141_2 and the data line 143_1, the pixel P12 is coupled to the scanning line 141_2 and the data line 143_4, and the rest are shown in the figure and thus not reiterated herein.

The gate driver 120 is controlled by the timing controller 110 and outputs a plurality of scanning signals SC1-SC6 to the scanning lines 141_1-141_6. The scanning line 141_1 is disposed corresponding to coupling structures of the pixels (i.e. P11, P12). However, the scanning line 141_1 can also be adopted to drive the pixels in other embodiments. Assuming the display panel 140 is driven by driving three rows of pixels simultaneously, then three neighboring scanning signals (i.e. SC2-SC4) are the same signals.

On the other hand, the source driver 130 is also controlled by the timing controller 110 for outputting a plurality of pixel voltages (i.e. VP1-VP9) correspondingly to the driven pixels (i.e. P11, P12, P21, P22, and so on) so as to store the corresponding pixel voltage in each of the pixels. After all of the pixels (i.e. P11, P12, P21, P22, and so on) have stored the pixel voltages (i.e. VP1-VP9), the backlight module 150 provides a surface light source needed by the display panel 140, such that an image is displayed through the surface light source.

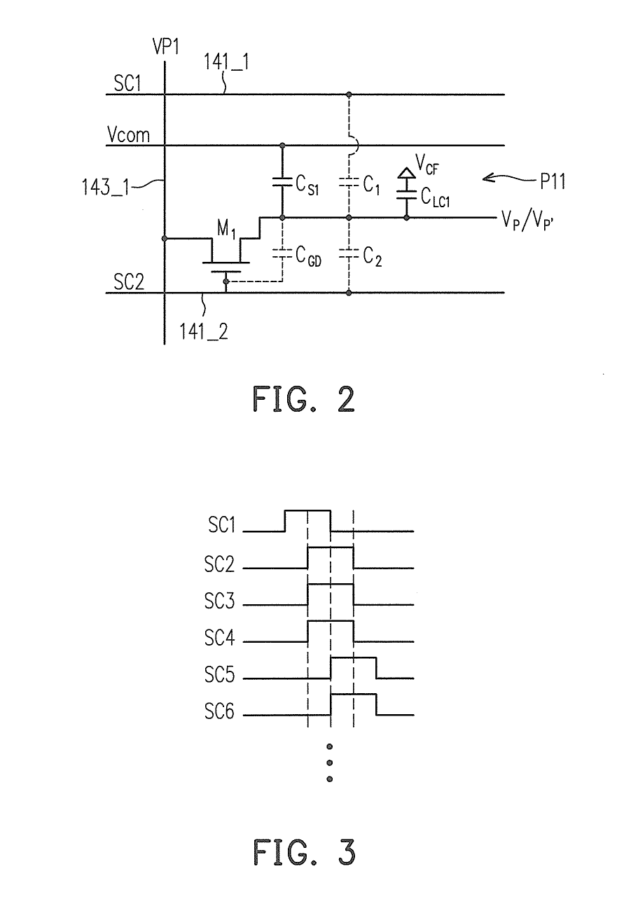

FIG. 2 shows a schematic circuit diagram of a pixel P11 in FIG. 1 according to an embodiment of the invention. Referring to FIG. 2, the pixel P11 includes a first switch (implemented by a transistor M₁ herein), a first storage capacitor C_{S1}, a first liquid crystal capacitor C_{LC1}, a first capacitor C₁, a second capacitor C₂, and a gate drain capacitor C_{GD}. Here, the first capacitor C₁ is a coupling capacitor of a pixel electrode of the pixel P11 and the scanning line 141_1. The second capacitor C₂ is a coupling capacitor of the pixel electrode of the pixel P11 and the scanning line 141_2. The gate drain capacitor C_{GD} is an equivalent capacitor between a gate of the transistor M₁ and a source of the same.

The source (that is, a first end) of the transistor M₁ is coupled to the data line 143_1 to receive the pixel voltage VP1 (that is, a first pixel voltage). The gate (that is, a control end) of the transistor M₁ is coupled to the scanning line 141_2 (that is, a second scanning line). The first storage capacitor C_{S1} is coupled between a drain (that is, a second end) of the transistor M₁ and a common voltage Vcom. The first liquid crystal capacitor C_{LC1} is coupled between the drain of the transistor M₁ and a common voltage V_{CF}. The first capacitor C₁ is coupled between the scanning line 141_1 (that is, a first scanning line) and the drain of the transistor M₁. The second capacitor C₂ is coupled between the scanning line 141_2 and the drain of the transistor M₁. The remaining pixels (i.e. P12, P21, and so on) have circuit structures similar to that of the pixel P11. However, they are different from the pixel P11 in the scanning lines they coupled to, the neighboring scanning lines, or the data lines they coupled to. FIG. 1 is used as an reference for illustration, and the descriptions are omitted herein.

FIG. 3 shows a waveform of a plurality of scanning signals SC1-SC6 in FIG. 1 according to an embodiment of the invention. Referring to FIGS. 1-3, it is assumed that devices adopted by a circuit of each of the pixels have the same parameters. Take pixel P11 as an example, when the scanning signal SC1 is a gate low voltage V_{GL} and the scanning signal SC2 is a gate high voltage V_{GH}, the transistor M₁ is conducted such that the pixel voltage VP1 charges the first storage capacitor C_{S1}, the first liquid crystal capacitor C_{LC1}, the first capacitor C₁, the second capacitor C₂, and the gate drain capacitor C_{GD}.

At this time, the pixel electrode of the pixel P11 is assumed to have a pixel voltage of Vₚ, a charge quantity of the first liquid crystal capacitor C_{LC1} is Q_{LC1}=C_{LC1}(V_{P}−V_{CF}). In the equation, C_{LC1} is the capacitance of the first liquid crystal capacitor C_{LC1}. A charge quantity of the first storage capacitor C_{S1} is Q_{S1}=C_{S1}(V_{P}−Vcom). In the equation, C_{S1} is the capacitance of the first storage capacitor C_{S1}. A charge quantity of the gate drain capacitor C_{GD} is Q_{GD}=C_{GD}(V_{P}−V_{GH}). In the equation, C_{GD} is the capacitance of the gate drain capacitor C_{GD}. A charge quantity of the first capacitor C₁ is Q_{C1}=C₁(V_{P}−V_{GL}). In the equation, C₁ is the capacitance of the first capacitor C₁. A charge quantity of the second capacitor C₂ is Q_{C2}=C₂(V_{P}−V_{GH}). In the equation, C₂ is the capacitance of the second capacitor C₂.

When the scanning signal SC1 is the gate low voltage V_{GL} and the scanning signal SC2 is the gate low voltage V_{GL}, the transistor M₁ is not conducted. Here, the pixel electrode of the pixel P11 is assumed to have the pixel voltage of V_{P′}. The charge quantity of the first liquid crystal capacitor C_{LC1} is Q_{LC1}=C_{LC1}(V_{P′}−V_{CF}). The charge quantity of the first storage capacitor C_{S1} is Q_{S1}=C_{S1}(V_{P′}−Vcom). The charge quantity of the gate drain capacitor C_{GD} is Q_{GD}=C_{GD}(V_{P′}−V_{GL}). The charge quantity of the first capacitor C₁ is Q_{C1}=C₁(V_{P′}−V_{GL}). The charge quantity of the second capacitor C₂ is Q_{C2}=C₂(V_{P′}−V_{GL}).

Accordingly, a pixel voltage difference ΔP11 of the pixel P11 before and after the pixel voltage VP1 is input can be acquired, and the equation is presented below:

$$Δ P 11 = {V}_{P} - {V}_{{P}^{′}} = \frac{{C}_{GD} + {C}_{2}}{{C}_{LC 1} + {C}_{SI} + {C}_{GD} + {C}_{1} + {C}_{2}} ( {V}_{GH} - {V}_{GL} ) \qquad ( 1 )$$

On the other hand, take pixel P21 as an example, when the scanning signal SC1 is a gate low voltage V_{GL} and the scanning signal SC3 is a gate high voltage V_{GH}, the transistor M₁ of the pixel P21 is conducted such that a pixel voltage VP2 charges the first storage capacitor C_{S1}, the first liquid crystal capacitor C_{LC1}, the first capacitor C₁, the second capacitor C₂, and the gate drain capacitor C_{GD} of the pixel P21. The charge quantity Q_{LC1} of the first liquid crystal capacitor C_{LC1}, the charge quantity Q_{S1} of the first storage capacitor C_{S1}, the charge quantity Q_{GD} of the gate drain capacitor C_{GD}, and the charge quantity Q_{C2} of the second capacitor C₂ of the pixel P21 are the same as those of the pixel P11. However, the details are not repeated here. The charge quantity of the first capacitor C₁ of the pixel P21 is Q_{C1}=C₁(V_{P}−V_{GH}).

When the scanning signal SC1 is the gate low voltage V_{GL} and the scanning signal SC3 is the gate low voltage V_{GL}, the transistor M₁ of the pixel P21 is not conducted. At this time, the charge quantity Q_{LC1} of the first liquid crystal capacitor C_{LC1}, the charge quantity Q_{S1} of the first storage capacitor C_{S1}, the charge quantity Q_{GD} of the gate drain capacitor C_{GD}, and the charge quantity Q_{C1} of the first capacitor, and the charge quantity Q_{C2} of the second capacitor C₂ of the pixel P21 are the same as those of the pixel P11. However, the details are not repeated herein.

Accordingly, a pixel voltage difference ΔP21 of the pixel P21 before and after the pixel voltage VP2 is input can be acquired, and the equation is presented below:

$$Δ P 21 = {V}_{P} - {V}_{{P}^{′}} = \frac{{C}_{GD} + {C}_{1} + {C}_{2}}{{C}_{LC 1} + {C}_{SI} + {C}_{GD} + {C}_{1} + {C}_{2}} ( {V}_{GH} - {V}_{GL} ) \qquad ( 2 )$$

In addition, a pixel voltage difference ΔP31 of a pixel P31 and a pixel voltage difference ΔP51 of a pixel P51 are the same as the pixel voltage difference ΔP21 of the pixel P21. A pixel voltage difference ΔP41 of a pixel P41 is the same as the pixel voltage difference ΔP11 of the pixel P11. Accordingly, in the multiple row of pixels being driven simultaneously, a pixel voltage difference of the first row of pixels is smaller than pixel voltage differences of the other rows of pixels, such that the first row of pixels is brighter (when displayed with positive polarity) or darker (when displayed with negative polarity).

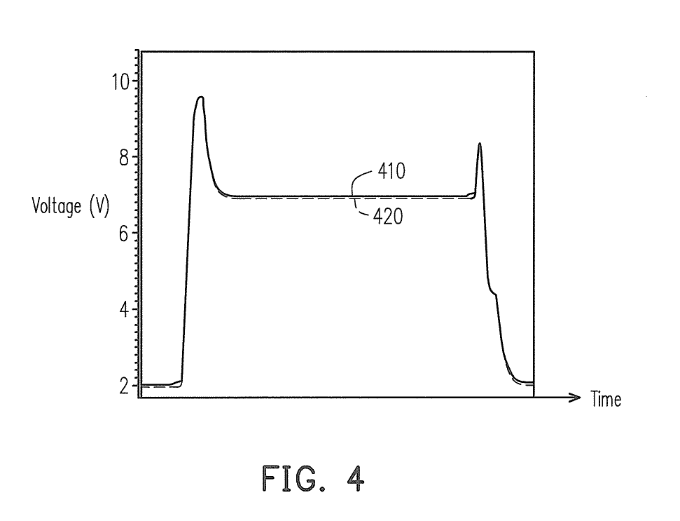

FIG. 4 illustrates a waveform of pixel voltages of the pixel P11 and a pixel P21 in FIG. 1 according to an embodiment of the invention. Referring to FIG. 4, in the present embodiment, a curve 410 is a pixel voltage waveform of the pixel P11 and a curve 420 is a pixel voltage waveform of the pixel P21. From FIG. 4, it is clear that the pixel voltage of the pixel P11 during display is higher than that of the pixel P21. This results as the pixel voltage difference ΔP11 of the pixel P11 is smaller than the pixel voltage difference ΔP21 of the pixel P21. In order to eliminate the effects caused by the pixel voltage difference, a plurality of method is provided below.

Firstly, according to equation (1) and equation (2), the difference between the pixel voltage difference ΔP11 and the pixel voltage difference ΔP21 is caused by different numerators. Here, the capacitance of the second capacitor C₂ is adjusted. The adjusted second capacitor C₂′=C₁+C₂. That is, the capacitance of the original second capacitor C₂ is increased to the sum of the capacitance of the second capacitor C₂ and the capacitance of the first capacitor C₁. Here, the adjustment of the capacitance of the second capacitor C₂ is implemented by adjusting an overlapped area of the pixel electrode of the pixel P11 and the scanning line 141_2. However, the embodiments of the invention are not limited thereto. Moreover, since the increase of the capacitance of the second capacitor C₂ also leads to the increase of the denominator, the capacitance of the first capacitor C₁ is subtracted from the capacitance of the first storage capacitor C_{S1} to maintain the size of the denominator.

Secondly, according to equation (1), when the denominator decreases, the pixel voltage difference ΔP11 then increases, so that the capacitance of the first storage capacitor C_{S1} is decreased for the pixel voltage difference ΔP11 to equal the pixel voltage difference ΔP21. The capacitance ΔC_{S} after the decrease of the capacitance of the first storage capacitor C_{S1} is shown in the following:

$$Δ {C}_{S} = \frac{{C}_{GD} + {C}_{2} ( {V}_{GH} - {V}_{GL} )}{Δ VP 21} - {C}_{LC 1} - {C}_{GD} - {C}_{1} - {C}_{2} = {nC}_{S 1}$$

Here, n is a constant and a ratio value of the capacitances ΔC_{S} and C_{S1}.

Thirdly, according to equation (1), since the gate high voltage V_{GH} in equation (1) comes from the scanning signal SC2, when the gate high voltage V_{GH} of the scanning signal SC2 is increased, the pixel voltage difference ΔP11 is also increased, so that the pixel voltage difference ΔP11 equals to the pixel voltage difference ΔP21. The gate high voltage ΔV_{GH} after the adjustment of the scanning signal SC2 is shown in the following:

$$Δ {V}_{GH} = Δ P 21 \frac{{C}_{LC 1} + {C}_{S 1} + {C}_{GD} + {C}_{1} + {C}_{2}}{{C}_{GD} + {C}_{2}} + {V}_{GL} = k {V}_{GH}$$

Here, k is a constant and a ratio value of the voltages ΔV_{GH} and V_{GH}.

Fourthly, since the pixel voltage of the pixel P11 during display is higher than that of the pixel P21, a line impedance of the scanning line 141_2 is increased so that the voltage of the gate of the transistor M₁ in pixel P11 is lowered. Accordingly, when displaying the same grayscales, the voltage of the drain (that is, the pixel voltage) is reduced to the same pixel voltage for displaying the pixel P21.

In summary, in the display apparatus and the display panel in the embodiments of the invention, the capacitance of the second capacitor, the capacitance of the first storage capacitor, the voltage level of the gate high voltage of the scanning signal SC2, or the line impedance of the scanning line 141_2 can be adjusted. Accordingly, the pixel voltage difference of the pixel P11 is the same as the pixel voltage difference of the pixel P21; or, the pixel voltage of the pixel P11 during display is the same as that of the pixel P21 when displaying the same grayscales.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display panel, comprising:
a first scanning line, receiving a first scanning signal;
a plurality of second scanning lines, receiving a second scanning signal, wherein the second scanning signal is different from the first scanning signal;
a plurality of first pixels, each of the first pixels comprising:
a first switch, having a first end receiving a first pixel voltage and a control end coupled to the corresponding second scanning line;
a first storage capacitor, coupled between a second end of the first switch and a common voltage;
a first liquid crystal capacitor, coupled to the second end of the first switch;
a first capacitor, coupled between the first scanning line and the second end of the first switch; and
a second capacitor, coupled between the corresponding second scanning line and the second end of the first switch; and
a plurality of second pixels, coupled to the two corresponding second scanning lines respectively, each of the second pixels comprising:
a second switch, having a first end receiving a second pixel voltage and a control end coupled to one of the two corresponding second scanning lines;
a second storage capacitor, coupled between a second end of the second switch and the common voltage;
a second liquid crystal capacitor, coupled to the second end of the second switch;
a third capacitor, coupled between another one of the two corresponding second scanning lines and the second end of the second switch; and
a fourth capacitor, coupled between one of the two corresponding second scanning lines and the second end of the second switch,
wherein by adjusting a capacitance of the second capacitor, a capacitance of the first storage capacitor, a voltage level of the second scanning signal corresponding to the first pixels, or a line impedance of the second scanning line corresponding to the first pixels, a pixel voltage difference of the first storage capacitor equals to a pixel voltage difference of the second storage capacitor.

2. The display panel as claimed in claim 1, wherein the capacitance of the second capacitor equals to a sum of a capacitance of the third capacitor and a capacitance of the fourth capacitor, and the capacitance of the first storage capacitor equals to a capacitance of the second storage capacitor subtracting a capacitance of the third capacitor.

3. The display panel as claimed in claim 1, wherein the capacitance of the first storage capacitor is smaller than a capacitance of the second storage capacitor.

4. The display panel as claimed in claim 1, wherein the voltage level of the second scanning signal corresponding to the first pixels is higher than voltage levels of the remaining second scanning signals.

5. The display panel as claimed in claim 1, wherein the line impedance of the second scanning line corresponding to the first pixels is higher than line impedances of the remaining second scanning lines.

6. The display panel as claimed in claim 1, wherein the first capacitor, the second capacitor, the third capacitor, and the fourth capacitor are a coupling capacitor respectively.

7. A display apparatus, comprising:
a display panel, comprising:
a first scanning line, receiving a first scanning signal;
a plurality of second scanning lines, receiving a second scanning signal, wherein the second scanning signal is different from the first scanning signal;
a plurality of first pixels, each of the first pixels comprising:
a first switch, having a first end receiving a first pixel voltage and a control end coupled to the corresponding second scanning line;
a first storage capacitor, coupled between a second end of the first switch and a common voltage;
a first liquid crystal capacitor, coupled to the second end of the first switch;
a first capacitor, coupled between the first scanning line and the second end of the first switch; and
a second capacitor, coupled between the corresponding second scanning line and the second end of the first switch; and
a plurality of second pixels, coupled to the two corresponding second scanning lines respectively, each of the second pixels comprising:
a second switch, having a first end receiving a second pixel voltage and a control end coupled to one of the two corresponding second scanning lines;
a second storage capacitor, coupled between a second end of the second switch and the common voltage;
a second liquid crystal capacitor, coupled to the second end of the second switch;
a third capacitor, coupled between another one of the two corresponding second scanning lines and the second end of the second switch; and
a fourth capacitor, coupled between one of the two corresponding second scanning lines and the second end of the second switch;
a source driver, coupled to the first pixels and the second pixels to provide the first pixel voltage and the second pixel voltage thereto; and
a gate driver, coupled to the first scanning line and the second scanning lines to provide the first scanning and the second scanning signal thereto;
wherein by adjusting a capacitance of the second capacitor, a capacitance of the first storage capacitor, a voltage level of the second scanning signal corresponding to the first pixels, or a line impedance of the second scanning line corresponding to the first pixels, a pixel voltage difference of the first storage capacitor equals to a pixel voltage difference of the second storage capacitor.

8. The display apparatus as claimed in claim 7, wherein the capacitance of the second capacitor equals to a sum of a capacitance of the third capacitor and a capacitance of the fourth capacitor, and the capacitance of the first storage capacitor equals to a capacitance of the second storage capacitor subtracting a capacitance of the third capacitor.

9. The display apparatus as claimed in claim 7, wherein the capacitance of the first storage capacitor is smaller than a capacitance of the second storage capacitor.

10. The display apparatus as claimed in claim 7, wherein the voltage level of the second scanning signal corresponding to the first pixels is higher than voltage levels of the remaining second scanning signals.

11. The display apparatus as claimed in claim 7, wherein the line impedance of the second scanning line corresponding to the first pixels is higher than line impedances of the remaining second scanning lines.

12. The display apparatus as claimed in claim 7, wherein the first capacitor, the second capacitor, the third capacitor, and the fourth capacitor are a coupling capacitor respectively.

13. The display apparatus as claimed in claim 7, wherein the display panel is a liquid crystal display panel.

14. The display apparatus as claimed in claim 7, further comprising a backlight module configured to provide a surface light source required by the display panel.
